(19) United States
(12) Patent Application Publication
(10) Pub. No.: US 2008/0213601 A1
(43) Pub. Date: Sep. 4, 2008

(54) HIGH-WATER-REPELLENCY AND HIGH-SLIDABILITY COATING MEMBER, FABRICATION METHOD FOR SAME, AND HIGH-WATER-REPELLENCY AND HIGH-SLIDABILITY PRODUCT USING SAME

(76) Inventors: Yasuaki YAMAMOTO, Hitachi (JP); Akira SETOGAWA, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/041,097

(22) Filed: Mar. 3, 2008

(30) Foreign Application Priority Data
Mar. 2, 2007 (JP) 2007-053066

(51) Int. Cl. B32B 9/04; B05D 1/12

(52) U.S. Cl. 428/446; 427/180

(57) ABSTRACT

A high-water-repellency and high-slidability coating member according to the present invention comprises a base material and a silica coating film made of silica and silane hybrid modified fluororesin, wherein the silica coating film is applied to a surface of the base material.

### CLAIM OF PRIORITY

The present application claims priority from Japanese application serial no. 2007-053066 filed on Mar. 2, 2007, the content of which is hereby incorporated by reference into this application.

### BACKGROUND OF THE INVENTION

1. Field of the Invention

The present invention relates to a coating member in which high-water-repellency and high slidability are given to plastic, rubber, metal, ceramics, combination of those materials and organic base material made of low heat-resistance and low-strength organic material, such as paper, wood, bamboo, organic fiber; and the present invention also relates to a fabrication method of those members and a high-water-repellency and high-slidability product using the members.

2. Description of Related Art

It is possible to improve a product durability and to prolong its service life by adding water repellency and abrasion resistance to the surface of a base material, such as building materials made of plastic, rubber, metal, ceramics and the like, thereby making it possible to create a product with high added value. To do so, conventionally, various products have been researched and developed, however, it is considerably difficult to add both water repellency and high slidability to the surface of a base material, and there are few products that are put into practical use.

Among them, there is water-repellent coating commonly being used is polytetrafluoroethylene (PTFE) coating. However, since the coating is usually applied by baking, it is difficult to apply the coating to a base material with no heat resistance, and abrasion resistance is not sufficient. Accordingly, the practical use is very limited.

Also, conventionally, various methods of coating silicate and silica have been reported. For example, numerous technologies have been proposed, such as an inorganic coating agent for creating a stable coating film that does not easily crack, a method of creating a water resistant hyaline coating film, a composition for coating a metal base substance, and the like.

Thus, conventionally, the use of silicate and silica as stable, water resistant coating materials is a known technology as described in JP-A Hei 7 (1995)-2511, JP-A Hei 11 (1999)-181352, and JP-A-2000-287559. However, conventionally, in the same technology field, even if silicate and silica coating film is applied to a base material, it was not possible to provide water repellency and high slidability at the same time.

### SUMMARY OF THE INVENTION

Under those circumstances, in the light of the above-mentioned conventional technology, the inventors of the present invention have devoted ourselves to research to solve the problems with the conventional technology. As a result, the inventors found a simple and easy-to-use method of obtaining a high-water-repellency and high-slidability coating member by applying a silica coating film made of silica and silane hybrid modified fluororesin to the surface of a base material; and further made efforts to continue the research to achieve the present invention.

It is an objective of the present invention to provide a high-water-repellency and high-slidability coating member, which can simultaneously provide both water repellency and abrasion resistance for a base material. Further, it is another objective of the present invention to provide a fabrication method for the coating member. Furthermore, it is another objective of the present invention to provide a high-water-repellency and high-slidability product using the coating member.

(1) According to one aspect of the present invention, a high-water-repellency and high-slidability coating member comprises a base material and a silica coating film made of silica and silane hybrid modified fluororesin, wherein the silica coating film is applied to a surface of the base material.

In the above invention (1), the following modifications and changes can be made.

(i) The base material is selected from a group including plastic, rubber, metal, ceramics, wood, organic fiber, combination of those materials, and a lamination of those materials.

(ii) The silica coating film further includes an organic silicon compound, photocatalyst, or photocatalyst precursor.

(iii) The photocatalyst is a titanium oxide particle.

(2) According to another aspect of the present invention, a fabrication method for a high-water-repellency and high-slidability coating member includes a step of forming a silica coating film made of silica and silane hybrid modified fluororesin on an organic base material.

In the above invention (2), the following modifications and changes can be made.

(iv) Fine silica particles, silica sol, or an organic silicon compound is used as a component of the silica, and a material in which a silane compound is grafted to modified fluororesin whose molecule has a radical as the result of the ionizing radiation under the condition with an oxygen concentration of 10 torr or less is used as a component of the silane hybrid modified fluororesin. Then, a solution containing the silica and the silane hybrid modified fluororesin is applied to a base material and dried to form a silica coating film.

(v) A silicate solution is applied to an organic base material and dried, and then acid or an acid-added silicate solution is applied to form a silica coating film made of silica and silane hybrid modified fluororesin.

(vi) A silicate solution is applied to an organic base material and dried, and then the silicate solution is applied again and exposed to a carbon dioxide gas to form a silica coating film made of silica and silane hybrid modified fluororesin.

(vii) A solution containing an organic silicon compound or silica sol includes a photocatalyst or photocatalyst precursor.

(viii) The photocatalyst is a titanium oxide particle.

(ix) A high-water-repellency and high-slidability product comprises said high-water-repellency and high-slidability coating member as a component.

### ADVANTAGES OF THE INVENTION

According to the present invention, it is possible to provide excellent abrasion resistance in addition to high-water-repellency and high slidability for a base material such as organic polymers, thereby greatly contributing to expansion of the application range of organic polymers.

### DETAILED DESCRIPTION OF THE PREFERRED EMBODIMENTS

Hereafter, a preferred embodiment of the present invention will be described in detail. However, the present invention is not limited to the embodiments described herein.

The present invention is characterized in that a high-water-repellency and high-slidability coating member is produced by applying a silica coating film made of silica and silane hybrid modified fluororesin to a surface of a base material. In the present invention, it is preferable that plastic, rubber, metal, ceramics, wood, organic fiber, combination of those materials, and a lamination of those materials be used as an example of the above-mentioned base material. However, the material is not intended to be limited to those mentioned, and other materials equal to or similar to those mentioned can be used in the same manner.

A component of silica used in the present invention includes fine silica particles, silica sol, and an organic silicon compound. As an example, it is preferable that an organic silicon compound, such as methyl silicate, ethyl silicate, propyl silicate, butyl silicate, alkoxysilane, or a mixture of those materials, be used; and among those, methyl silicate and ethyl silicate are most preferable from the viewpoint of cost and easy procurement. Furthermore, silica sol used in the present invention includes, for example, an organic silicon compound or silicate that has been neutralized or hydrolyzed by acid or alkali, and dispersed fine silica particles.

Fluororesin used in the present invention includes polytetrafluoroethylene (PTFE), polytetrafluoroethylene-fluoroalkoxytrifluoroethylene (PFA), and polytetrafluoroethylene-hexafluoropropylene (FEP). The above-mentioned PTFE includes substances that contain 0.2 mol % or less of perfluoro (alkyl vinyl ether), hexafluoropropylene, (perfluoro alkyl)ethylene or chlorotrifluoroethylene in the polymerization unit based on the copolymerized monomer. Also, the above-mentioned fluororesin may contain a small amount of third component in its molecule structure.

A modified fluororesin compact according to the present invention can be produced by applying ionizing radiation to a fluororesin compact with a range of radiation dose between 1 kGy and 10 MGy under an inert gas atmosphere with an oxygen concentration of 10 torr or less and also being heated above its melting point. The ionizing radiation should be applied under an inert gas atmosphere with an oxygen concentration of 10 torr or less and also being heated above the melting point, and the radiation dose is desirably in the range between 1 kGy and 10 MGy. As ionizing radiation, y-ray, electron beam, X-ray, neutron radiation or high-energy ions are used in the present invention.

When applying ionizing radiation, it is necessary to heat a fluororesin compact to a temperature above its crystalline melting point. For example, when PTFE is used as fluororesin, it should be heated to temperatures above its melting point 327° C. When PFA or FEP is used, it should be heated to temperatures above its identified melting point (PFA 310° C. and FEP 275° C.) and then ionizing radiation should be applied. By heating fluororesin to temperatures above its melting point, molecular motion of the main chain of fluororesin is activated, thereby making it possible to efficiently promote a cross-linking reaction among molecules. However, excessive heat will result in the destruction of the main molecular chain; therefore, the heating up temperature should be limited within a range from 10 to 30° C. higher than the melting point of fluororesin.

Silane hybrid modified fluororesin based on the above substance is created such that the ionizing radiation of between 1 to 50 kGy is applied to the above-mentioned modified fluororesin under an inert gas atmosphere with an oxygen concentration of 10 torr or less to form an active radical in the molecule of the modified fluororesin and then a silane compound reacts with the modified fluororesin so that they are grafted to each other. The silane hybrid modified fluororesin thus created has a high affinity for silica, and accordingly, it also develops an excellent anti-scratch property in addition to high-water-repellency and high slidability.

According to the present invention, it is also possible to add an organic silicon compound to the silica coating film in order to increase adhesion between a metal base material and a film.

Furthermore, in the present invention, a photocatalyst can be used to increase an antifouling property. Photocatalysts are, e.g., metal oxides such as titanium oxide, zinc oxide, lead oxide, tin oxide, and ferric oxide; metallic sulfide such as cadmium sulfide and molybdenum sulfide; ceramics including perovskite compound; metallic complex including ruthenium complex; organic semiconductors such as polyphthalocyanine and polyaniline. Preferable photocatalysts are, e.g., titanium oxides such as anatase and brookite; titanium oxides doped with nitrogen and sulfur, and titanium oxides made into light response type by introducing an oxygen defect.

Photocatalyst precursors used in the present invention are, e.g., organic titanium including titanium alkoxide, peroxides (peroxotitanic acid), and titanium metallic complex; those substances are not originally photocatalysts but become photocatalysts after being heated or dried. Specifically, organic titanium compounds such as titanium alkoxide and acetylacetonato, and peroxide titanate are preferable. It is preferable that the quantity of organic silicon compound, photocatalyst, or photocatalyst precursor added to the above-mentioned silica coating film be 0.1 to 1 weight percentage (parts by weight) with regard to 100 weight percentage (parts by weight) of a mixture of silica and the silane hybrid modified fluororesin.

As described before, it is preferable that a high-water-repellency and high-slidability coating member according to the present invention be produced by a simple and easy-to-use method in which a silica coating film made of silica and silane hybrid modified fluororesin is applied to the surface of a base material made of plastic, rubber, metal, ceramics, wood, organic fiber, combination of those materials, or a lamination of those materials.

At that time, an organic silicon compound in the coating film reacts with moisture in the air to form a silica coating film. Furthermore, when a solution containing silica sol made by neutralizing or hydrolyzing an organic silicon compound or silicate by acid or alkali, or made by dispersing fine silica particles is applied, a silica coating film will be formed by drying the applied solution.

Furthermore, a silica coating film can be obtained by applying an acid-added silicate solution or a silicate solution and by being exposed to acid or a carbon dioxide gas. The obtained silica coating film, which has been crystallized, is dense and watertight and also blends with silane hybrid modified fluororesin; therefore, the silica coating film has excellent water repellency and slidability. In that procedure, if a photocatalyst or photocatalyst precursor is added to the solution containing an organic silicon compound or silica sol, a silica coating film containing the photocatalyst can be obtained. Thus, due to the photocatalysis, a coating member with an excellent antifouling property can be obtained.

Methods of applying the above-mentioned solution to the base material are achieved, e.g., by brushing, spray coating, dip coating, roll coating, and printing.

Furthermore, the film can be dried at room temperature or by heating, and the film that is heated forms quickly. To dry a film by heating, infrared heating, ultraviolet heating, and heating by a dryer can be executed.

According to the present invention, by using the above-mentioned high-water-repellency and high-slidability coating member, it is possible to create and provide a high-water-repellency and high-slidability product. High-water-repellency and high-slidability products in the present invention include, e.g., plastic products, rubber products, metal products, ceramic products and products made of a combination of those materials.

One of the greatest features of the present invention is not only to provide high-water-repellency and high slidability properties for a base material, but also specifically to increase the strength of the organic base material made of organic material, thereby making it possible to improve the product durability and prolong its service life.

Furthermore, the coating film on the surface of a coating member according to the present invention, which is mainly made of silica and silane hybrid modified fluororesin, has an anti-scratch property, heat resistant and flame retardant. By applying the coating film to a combustible organic base material, such as plastic, it is possible to significantly increase an anti-scratch property as well as provide flame retardancy. Moreover, the finished product is highly water resistant because the surface of the formed film is dense silica. Also, since silica is superhydrophilic, smudges can be easily removed or washed off.

Thus, the present invention relates to a high-water-repellency and high-slidability coating member and a fabrication method thereof, and according to the present invention, it is possible to provide a coating member having high-water-repellency and high slidability on the surface of a base material.

### EXAMPLES

Next, the present invention will be specifically described by using an example; however, the present invention is not intended to be limited by the example.

TABLE 1
Blending quantity is weight percentage (parts by weight).

| | | Example | | | | Comparative example | | |
|---|---|---|---|---|---|---|---|---|
| Item | | 1 | 2 | 3 | 4 | 1 | 2 | 3 |
| Composition | Silica A | 70 | 60 | 50 | | 100 | 60 | 60 |
| | Silica B | | | | 60 | | | |
| | Modified PTFE | | | | | | | 40 |
| | Silane hybrid | 30 | 40 | 50 | 40 | | | |
| | modified PTFE | | | | | | | |
| | PTFE | | | | | | 40 | |
| Characteristics | Water repellency | | | | | | | |
| | Contact angle | 120 | 124 | 130 | 135 | 70 | 82 | 128 |
| | Slidability | 12000 | 9000 | 6500 | 7100 | 120000 | 100000 | 11000 |
| | Specific wear | | | | | | | |
| | volume | | | | | | | |
| | Friction | 0.39 | 0.35 | 0.34 | 0.33 | 0.57 | 0.53 | 0.35 |
| | coefficient | | | | | | | |
| | Anti-scratch | Good | Good | Good | Good | Good | Poor | Poor |
| | property | | | | | | | |

Silica A: Silica sol 50 wt % isopropyl alcohol solution in which methyl silicate is hydrolyzed by acetic acid
Silica B: Silica gel 50 wt % ethyl alcohol solution in which ethyl silicate is hydrolyzed by hydrochloric acid
Slidability: Specific wear volume (×10⁻⁸ mm³/Nm)

In these Examples 1 to 4 and Comparative examples 1 to 3, a high-water-repellency and high-slidability coating member was created by using an aluminum plate as a base material.

(1) Fabrication of Member

A triethylmethoxysilane ethanol solution of 0.001 wt % was sprayed on the surface of 2-mm thick aluminum plate and then dried by an infrared lamp. This procedure was repeated three times. Subsequently, a solution of the composition shown in Table 1 was applied to the aluminum plate uniformly and hydrolyzed by moisture in the air, and then a 30-μm thick coating was executed.

Asahi Glass Co., Ltd. product P-192 was used as PTFE in Comparative example 2. To create a modified PTFE, an electron beam (accelerating voltage 2 MeV) of 100 kGy was directed at the PTFE under a nitrogen atmosphere with an oxygen concentration of 1 torr and being heated at a temperature of 340° C. Then, the modified substance was finely milled into particles with average diameter of 20 μm by a jet mill, and used as modified PTFE in Comparative example 3.

Silane hybrid modified fluororesin used in Examples 1 to 4 was created such that 10 kGy electron beam (accelerating voltage 2 MeV) was directed at the finely-milled powder of the modified fluororesin under a nitrogen atmosphere with an oxygen concentration of 1 torr and being heated at temperature of 20° C., and then 1 weight percentage (parts by weight) (diluted by ethanol to 20 wt %) of vinyltrimethoxysilane was added with regard to 100 weight percentage (parts by weight) of modified fluororesin, thereby grafting a silane coupling agent to the modified fluororesin to become hybrid. The grafting was executed by reacting for one hour at a temperature of 50° C.

(2) Test Method and Results

The coating member thus prepared was evaluated for water repellency and slidability characteristics. By using a contact angle gauge CA-D made by Kyowa Interface Science Co., Ltd. and adjusting the diameter of a droplet to 1.9 mm, the water repellency was evaluated according to the contact angle of water.

The slidability characteristic was evaluated by the following method. The test was conducted by using a ring-on-desk abrasion test apparatus in accordance with JIS K7218 wherein a SUS304 cylindrical ring (outer diameter of 25.6 mm, inner diameter of 20.6 mm, average roughness of 0.6 μm) and the test specimen were made sliding. Test conditions were a pressure of 0.1 MPa, a velocity of 50 m/min, and an atmosphere of 20° C. in the air; and specific wear volume and coefficient of friction were measured after 20 minutes.

Weight decrease after 20 minutes was measured and specific wear volume V_{SA} was calculated by the following equation.

V_{SA}=V/(PL)

V: wear volume, P: test load, L: average sliding distance

An anti-scratch property was evaluated by means of pencil hardness (JIS K5400). The scratch test was conducted by attempting to scratch the coated surface of the above-mentioned coated member by pencils of different degrees of hardness; and the surface that did not have scars after been scratched by a pencil of hardness 4H was regarded as being good, and the surface that had scars was regarded as being poor.

As shown in Table 1, Examples 1 to 4 according to the present invention have a high contact angle, excellent water repellency, and good abrasion resistance. Also, coefficient of friction is low, and those Examples have a low frictional property and an excellent anti-scratch property.

On the contrary, in Comparative example 1 that does not include modified fluororesin, the contact angle is low, water repellency is inferior, and abrasion resistance is also low. Comparative example 2 that uses unmodified fluororesin (PTFE) has poor dispersibility, and also has a low contact angle and inferior water-repellency, low abrasion resistance and inferior anti-scratch property similar to Comparative example 1. Comparative example 3 that uses modified PTFE instead of using silane hybrid modified fluororesin has an inferior anti-scratch property.

As clearly indicated by comparison between Examples 1 to 4 and Comparative examples 1 to 3, by forming a coating film made of silica and silane hybrid modified fluororesin on the surface of a base material, it is possible to provide excellent abrasion resistance in addition to high-water-repellency and high slidability, thereby expanding the application range of the base material (e.g., organic polymers).

That is, it is possible to provide high-water-repellency and high slidability for plastic, rubber, metal, ceramics, and combination of those materials, and also for organic base materials made of organic materials having no heat resistance and low strength, such as paper, wood, bamboo, organic fiber, and the like; consequently, new technology and new industry will be created in this field.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A high-water-repellency and high-slidability coating member, comprising: a base material and a silica coating film made of silica and silane hybrid modified fluororesin, wherein the silica coating film is applied to a surface of the base material.

2. The high-water-repellency and high-slidability coating member according to claim 1, wherein:
the base material is selected from a group including plastic, rubber, metal, ceramics, wood, organic fiber, combination of those materials, and a lamination of those materials.

3. The high-water-repellency and high-slidability coating member according to claim 1, wherein:
the silica coating film further includes an organic silicon compound, photocatalyst, or photocatalyst precursor.

4. The high-water-repellency and high-slidability coating member according to claim 3, wherein:
the photocatalyst is a titanium oxide particle.

5. A fabrication method for a high-water-repellency and high-slidability coating member, including a step of forming a silica coating film made of silica and silane hybrid modified fluororesin on an organic base material.

6. The fabrication method for a high-water-repellency and high-slidability coating member according to claim 5, wherein:
fine silica particles, silica sol, or an organic silicon compound is used as a component of the silica, and a material in which a silane compound is grafted to modified fluororesin whose molecule has a radical as the result of the ionizing radiation under the condition with an oxygen concentration of 10 torr or less is used as a component of the silane hybrid modified fluororesin; then, a solution containing the silica and the silane hybrid modified fluororesin is applied to a base material and dried to form a silica coating film.

7. The fabrication method for a high-water-repellency and high-slidability coating member according to claim 5, wherein:
a silicate solution is applied to an organic base material and dried, and then acid or an acid-added silicate solution is applied to form a silica coating film made of silica and silane hybrid modified fluororesin.

8. The fabrication method for a high-water-repellency and high-slidability coating member according to claim 5, wherein:
a silicate solution is applied to an organic base material and dried, and then the silicate solution is applied again and exposed to a carbon dioxide gas to form a silica coating film made of silica and silane hybrid modified fluororesin.

9. The fabrication method for a high-water-repellency and high-slidability coating member according to claim 5, wherein:
a solution containing an organic silicon compound or silica sol includes a photocatalyst or photocatalyst precursor.

10. The fabrication method for a high-water-repellency and high-slidability coating member according to claim 9, wherein:
the photocatalyst is a titanium oxide particle.

11. The high-water-repellency and high-slidability product, comprising the high-water-repellency and high-slidability coating member according to claim 1 as a component.
